(19) United States
(12) Patent Application Publication
(10) Pub. No.: US 2005/0240485 A1
(43) Pub. Date: Oct. 27, 2005

(54) dOrder.com Procurement Site

(75) Inventor: Richard Ponti, Los Angeles, CA (US)

Correspondence Address: RICHARD PONTI, 6513 W. ORANGE STREET, LOS ANGELES, CA, 90048, US

(73) Assignee: Richard Ponti, Los Angeles, CA (US)

(21) Appl. No.: 10/709,269

(22) Filed: Apr. 26, 2004

(51) Int. Cl. G06F 17/60

(52) U.S. Cl. 705/26

(57) ABSTRACT

A procurement site that makes it easy to order according to price and quality, record requisitions, purchase orders, vendor invoices and receiving records. An easy and clear paperless approval system and reports that show buyers and vendors detail history of all transactions.

### DETAILED DESCRIPTION

This web site is been designed to be used by hotels and restaurant procurement personnel and their vendors. However the site will prove useful to any procurement department from any business.

www.dOrder.com is showing the buyers and the management of the buying business, vendor prices for the same specific item, arranged side by side. The buyer will see competitive prices from his vendors and be able to see a total dollar amount for his current order, according to the prices of each individual vendor that he is buying from.

Before the order is finalized, the buyers can see budget figures for the year and current month and how do they compare with the actual dollars spend so far for the year and current month.

The site facilitates an approval system of all orders. Orders can be view and edited by the management personnel involved in the procurement process. Orders can be started by the lowest level of buyers that can be authorized to buy for certain business departments. The order so created is called a requisition. The requisition will be labeled with the Department Name, Date, Category of Items ordered, Required Delivery Date, General Ledger reference number, Items, Quantities to be ordered, and prices from all the vendor this business if buying from at the time. The requisition is then available for the approval of the higher management. Each higher management personnel, in turn, can view and approve the requisition, till the higher level is attained and the requisition is approved, partially approved or rejected. Than the requisition becomes available to the designated management team member, to be send to the chosen vendor or vendors. If there are multiple vendors that do provide prices for the category of items, than the designated buyer in charge of sending orders to vendors, can chose to send the entire order to one single vendor, or split the order between the available vendors any way he/she chooses to, based on price or other criteria. The requisition is now call a Purchase Order and can be email, fax or just printed out and ordered over the phone.

The Purchase Order/s so created will now be available to the intended vendor/s. A representative of the vendor can log in at any time and view Purchase Orders from the businesses that they are selling to, can input the quantities that they can send at the required date, vendor's invoice number and date, and this now becomes an official vendor invoice that is waiting for the designated receiving person for the buyer's side to mark this invoiced as received as soon as the items so ordered will be delivered at the buyers company loading dock.

All transactions are recorded in to a SQL Server 2000 database. All the transactions history is available to the buyers and sellers in many detail reports.

This web site idea and work is rooted in my over twenty five years of hospitality industry experience. I been experimenting since 1985, with Excel based procurement applications, and since 1999 I been working on perfecting what can now be view, at www.dorder.com This is a work in progress, however, as I would like to make it even better and easier to use.

1. An easy way for hotels, restaurants or any other business to save procurement dollars and beat the budget.
